(19) United States
(12) Patent Application Publication
(10) Pub. No.: US 2024/0060767 A1
(43) Pub. Date: Feb. 22, 2024

(54) APPARATUS FOR MEASURING THICKNESS OF SEALING PORTION OF SECONDARY BATTERY AND METHOD FOR MEASURING THICKNESS OF SEALING PORTION USING SAME

(71) Applicants: SK ON CO., LTD., Seoul (KR); HANA TECHNOLOGY CO., Ltd., Gyeonggi-do (KR)

(72) Inventors: Young Rae OH, Daejeon (KR); Sang Jun PARK, Daejeon (KR); Ji Eun AHN, Daejeon (KR); Jeong Seok JEONG, Gyeonggi-do (KR)

(21) Appl. No.: 18/450,404

(22) Filed: Aug. 16, 2023

(30) Foreign Application Priority Data
Aug. 19, 2022 (KR) 10-2022-0103966

(51) Int. Cl. G01B 11/06

(52) U.S. Cl. CPC G01B 11/06

(57) ABSTRACT

The disclosure relates to apparatus for measuring the thickness of a sealing portion of a secondary battery, and the apparatus includes a non-contact measuring part including a pair of sensors disposed to face each other, and a controller detecting thickness information of the sealing part of the secondary battery, the information being collected by the non-contact measuring part, wherein the non-contact measuring part is able to measure the thickness in a non-contact manner while interposing the sealing part of the secondary battery between the pair of sensors. Furthermore, the disclosure includes a method for measuring the thickness of the sealing part of the secondary battery by using the above-described pair of sensors.

### CROSS REFERENCE TO RELATED APPLICATIONS

The present application claims priority to Korean Patent Application No. 10-2022-0103966, filed Aug. 19, 2022, the entire contents of which is incorporated herein for all purposes by this reference.

### BACKGROUND

### 1. Technical Field

The disclosure relates to apparatus for measuring the thickness of a sealing portion of a secondary battery and, more particularly, to apparatus for measuring the thickness of a sealing part of a pouch-type secondary battery.

Furthermore, the disclosure includes a method for measuring the thickness of a sealing portion of a secondary battery.

### 2. Description of the Related Art

In general, a secondary battery is a battery that can repeatedly perform charging and discharging, and is applied as a power source with output characteristics for an electric vehicle (EV), a hybrid electric vehicle (HEV), an energy storage system (ESS), and the like and stability.

Such secondary battery may be divided into a cylindrical battery, a prismatic battery (angular battery), and a pouch-type battery according to the exterior shape of a casing receiving the electrode assembly. Recently, demand for a thin pouch-type secondary battery is increasing.

The pouch-type secondary battery includes an electrode assembly formed by sequentially stacking a positive electrode, a separating film, and a negative electrode, a pouch receiving the electrode assembly and electrolyte, and an electrode lead electrically connected to the electrode assembly and drawn to the outside space. In order to seal the electrode assembly and the electrolyte in the pouch, a sealing part is formed by a bonding method such as thermal fusion on an outer edge portion of a pouch exterior material made of an aluminum laminate sheet.

As is widely known, in order to prevent insulation defect and/or sealing defect, the pouch-type secondary battery should provide a predetermined width size to the sealing part and at the same time maintain a constant bonding thickness of the sealing part in order to prevent not only leakage of the electrolyte filled in the pouch but also penetration of water into the pouch. In other words, in terms of cell performance, the thickness of the sealing part of the pouch-type secondary battery also acts as a great factor.

As disclosed in Patent Document 1, the thickness of the sealing part is measured by contacting a measuring probe to a pouch sealing surface, and in a process of contacting the probe with the sealing part surface of the pouch, damages to the pouch, e.g., to the sealing part due to probe often occur. Due to the product characteristics of the pouch-type secondary battery, a conventional measurement method has limitations in measuring accurately and precisely when the flatness of the sealing part is uneven. Moreover, the related art detects only the thickness of a measurement position by measuring the thickness of the sealing part discontinuously along a formation direction of the sealing part, and induces extension of tact time and reduction in process efficiency.

### DOCUMENTS OF RELATED ART

(Patent Document 1) Korean Patent Application Publication No. 10-2021-0085975

### SUMMARY

The disclosure is intended to provide apparatus that can measure precisely and continuously the thickness of a sealing part formed by bonding edges of a pouch in a fusion bonding manner.

The disclosure includes a method for measuring the thickness by using the thickness measurement apparatus.

In order to achieve the above objectives, apparatus for measuring the thickness of a sealing portion of a secondary battery according to the disclosure includes: a non-contact measuring part including a pair of sensors disposed to face each other; and a controller detecting thickness information of the sealing part of the secondary battery, the information being collected by the non-contact measuring part, wherein the non-contact measuring part is able to measure the thickness in a non-contact manner while interposing the sealing part of the secondary battery between the pair of sensors.

Preferably, the non-contact measuring part may be disposed to space the pair of sensors from each other at a sensor-to-sensor distance.

Optionally, according to the disclosure, a sensor-to-sensor distance may be preset larger than the thickness between an upper surface and a lower surface of the sealing part.

According to the embodiment of the disclosure, the sensors may include confocal sensors.

In addition, the disclosure may include a displacement part displacing a location of the non-contact measuring part with respect to the sealing part of the secondary battery.

In the embodiment of the disclosure, the secondary battery may be mounted to a linear motion system to be continuously moved in a direction perpendicular to an optic axis of the pair of sensors.

According to the disclosure, a method for measuring thickness of a sealing portion of a secondary battery includes: preparing a non-contact measuring part including a pair of sensors disposed to face each other; aligning the secondary battery in order to interpose the sealing part of the secondary battery between the pair of sensors; measuring the thickness of the sealing part in a formation direction of the sealing part by the non-contact measuring part; and analyzing data to determine thickness information collected by the non-contact measuring part, wherein the non-contact measuring part measures the thickness of the sealing part of the secondary battery in the non-contact manner.

The aligning of the secondary battery may include: presetting height of the secondary battery to correspond to a sensor-to-sensor distance; and presetting orienting so as for the sealing part of the secondary battery that is a measurement portion, to be located between the pair of sensors.

Preferably, according to the disclosure, the sealing part where an electrode lead is drawn outwards may be disposed between the pair of sensors.

In the measuring of the thickness of the sealing part, the sealing part of the secondary battery may be continuously moved in a direction perpendicular to an optic axis of the pair of sensors.

In the measuring of the thickness of the sealing part, the secondary battery may be mounted to a linear motion system to travel at a constant speed.

The pair of sensors may be disposed to be spaced from each other at a sensor-to-sensor distance that is larger than the thickness between an upper surface and a lower surface of the sealing part.

The above and other objects, features and advantages of the disclosure will be more clearly understood from the following detailed description when taken in conjunction with the accompanying drawings.

All terms or words used in the specification and claims have the same meaning as commonly understood by one of those skilled in the art to which inventive concepts belong. It will be further understood that terms, such as those defined in commonly used dictionaries, should be interpreted as having meanings that are consistent with their meanings in the context of the relevant art and will not be interpreted in an idealized or overly formal sense unless expressly so defined herein.

Hereinabove, according to the description of the disclosure, the disclosure is provided to measure the thickness of the sealing part of the secondary battery in the non-contact manner by means of the pair of sensors that are arranged to be spaced apart from each other at a predetermined sensor-to-sensor distance. Therefore, in the process of measuring the thickness of the sealing part, unexpected damages to the sealing part of the secondary battery can be prevented in advance.

Specifically, the disclosure can rapidly and continuously perform the thickness measurement in the non-contact manner in which the sealing part of the secondary battery passes through the interval between the pair of sensors, so that a total inspection can be performed instead of a sampling inspection, and a defect rate of the secondary battery can be minimized.

Moreover, the disclosure is provided to displace the non-contact measuring part including the pair of sensors to allow measurement without limitations in the size of the secondary battery.

As described in the disclosure, through the successive measurement method in the non-contact manner, not only the inspection process of the secondary battery can be simplified, but also the stability and the reliability of the secondary battery can be maintained.

### BRIEF DESCRIPTION OF THE DRAWINGS

FIG. 1 is a perspective view schematically showing a pouch-type secondary battery.

FIG. 2 is a schematic diagram apparatus for measuring the thickness of a sealing portion of a secondary battery according to an embodiment of the disclosure.

FIG. 3 is a view schematically showing arrangement between the apparatus for measuring the thickness of a sealing portion of a secondary battery according to the embodiment of the disclosure and a measurement target.

FIG. 4 is a perspective view schematically showing the apparatus for measuring the thickness of a sealing portion of a secondary battery according to another embodiment of the disclosure.

FIG. 5 is a front view showing the apparatus for measuring the thickness of a sealing portion of a secondary battery shown in FIG. 4, in a view of a travelling direction of the secondary battery.

FIG. 6 is a flowchart showing a method for measuring the thickness of a sealing portion of a secondary battery according to the disclosure.

### DETAILED DESCRIPTION

The above and other objects, features and advantages of the disclosure will be more clearly understood from the following detailed description taken in conjunction with the accompanying drawings, and the disclosure is not necessarily limited thereto. Furthermore, when it is determined that the detailed description of the known art related to the disclosure might obscure the gist of the disclosure, the detailed description thereof will be omitted.

The embodiment described in the specification and accompanying drawings should not be construed as being limited to only the embodiments set forth herein. The disclosure should be construed as covering modifications, equivalents, and/or alternatives of the disclosure.

As for reference numerals associated with parts in the drawings, the same reference numerals are used throughout the different drawings to designate the same or similar components.

In the specification, the terms first, second, etc. may be used herein to describe various components, and these components should not be limited by these terms. In the accompanying drawings, some components are exaggerated, omitted, or schematically shown, and the size of each component does not fully reflect the actual size.

Hereinbelow, an embodiment of the disclosure will be described in detail with reference to accompanying drawings.

The disclosure is to measure the thickness of a sealing part of a secondary battery. Particularly, the disclosure is provided to measure the thickness of the sealing part of the secondary battery in a non-contact manner with a pair of confocal sensors. Accordingly, the disclosure may continuously conduct measurement with respect to the thickness of the sealing part of the secondary battery to allow not only total inspection but also provide a characteristic of reducing measuring time.

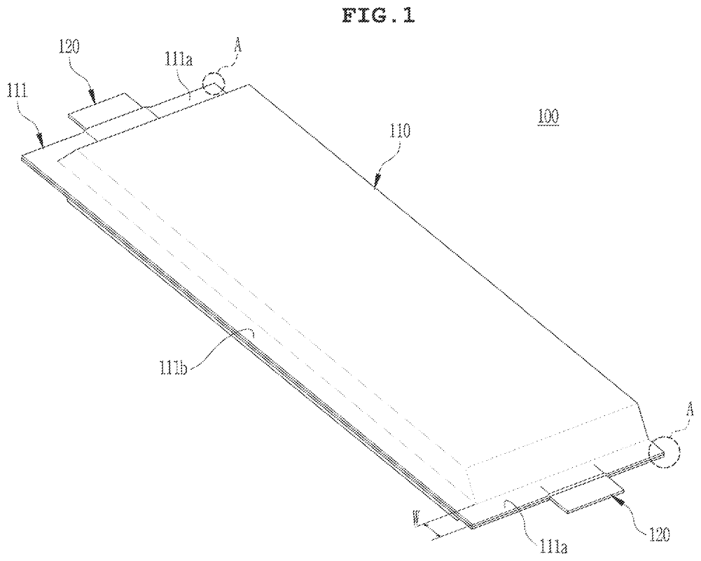

A secondary battery 100 includes an electrode assembly (not shown) to which an electrode lead 120 is coupled, and a pouch 110 including an upper pouch surrounding an upper portion of the electrode assembly and a lower pouch surrounding a lower portion of the electrode assembly. As shown in FIG. 1, the pouch 110 is formed by interposing the electrode lead 120 between an edge of the upper pouch and an edge of the lower pouch and performing heat fusion along the edge to form a sealing part 111 in a sealed state.

As is widely known to those skilled in the art, the pouch 110 receives an electrolyte therein with the electrode assembly, and while the upper pouch and the lower pouch face each other, the edges of the pouch are sealed to form the sealing part 111. At this point, the sealing part 111 may be divided into a non-flat side sealing portion 111a having irregular thickness and a flat side sealing 111b maintaining a constant thickness. As shown in the drawings, the non-flat side sealing portion 111a is located in one portion of the sealing part where the electrode lead 120 is drawn so that the non-flat side sealing portion 111a has a step formed therein by the thickness of the electrode lead. In addition, during a process in which the folding part A connecting the upper pouch to the lower pouch is folded in order to bond the upper pouch and the lower pouch together, a wrinkled portion is formed in an inner surface of the folding part, and thus the non-flat side sealing portion has the thickness thicker than the thickness of the flat side sealing portion.

Accordingly, the disclosure may determine a sealed state of the secondary battery by measuring the thickness of the sealing part of the secondary battery 100, more particularly, the thickness of the non-flat side sealing portion 111a. Of course, the disclosure is not limited to the non-flat side sealing as described above, and may be also applied to the flat side sealing, which is clear to those skilled in the art. For example, when a measured value of the thickness of the sealing part is less than a preset target value of the thickness of the sealing part, the value may be determined as destruction of an insulation layer of the sealing part. The pouch-type secondary battery allows current to flow only through the electrode lead, and destruction of the insulation layer of the sealing part as described above causes electrical contact between an aluminum laminate sheet and the electrode lead and thus the corrosion of the laminate sheet occurs, thereby affecting the stability of the secondary battery. On the other hand, when a measured value of the thickness of the sealing part is greater than the preset target value of the thickness of the sealing part, the value may be determined as occurrence of a non-sealed region in the sealing part. The secondary battery may have a disadvantage such as leakage of the electrolyte and/or water penetration into the pouch through the non-sealed region.

Moreover, although the disclosure is illustrated with the secondary battery in which electrode leads 120 extend bi-directionally (two ways) so as to direct from each other at opposite ends of the electrode assembly, the disclosure is also applied to other secondary batteries in which the electrode leads are spaced apart from each other at one end of the electrode assembly and extend in the same direction, i.e., one direction (one way) to be arranged in parallel to each other.

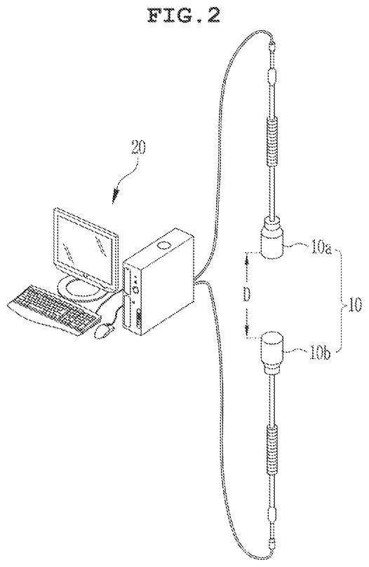

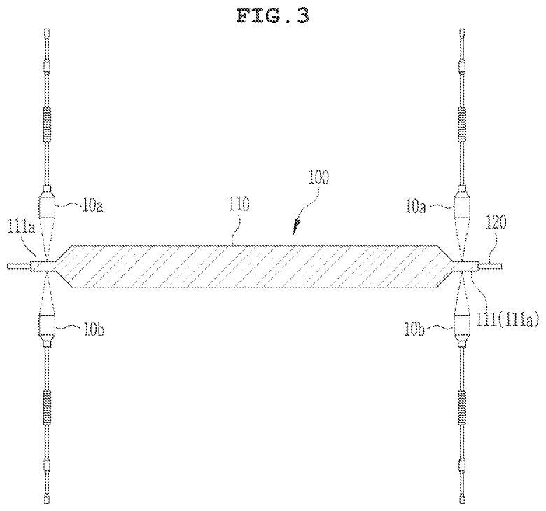

Referring to FIGS. 2 and 3, according to the embodiment of the disclosure, the apparatus for measuring the thickness of a sealing portion of a secondary battery (hereinbelow, which will be referred to as thickness measuring apparatus) includes a non-contact measuring part 10 including a pair of sensors 10a and 10b, and a controller 20 detecting thickness information of the sealing part of the secondary battery on the basis of data collected by the pair of sensors.

Preferably, the disclosure is provided to precisely measure the thickness of the sealing part 111 of the secondary battery 100 in the non-contact manner, specifically, to precisely measure the thickness of the non-flat side sealing portion 111a including the electrode lead, and the folding part.

The non-contact measuring part 10 includes the pair of sensors 10a and 10b disposed to face each other as shown in the drawing, and may measure the thickness of the sealing part 111 at high precision by means of the pair of sensors 10a and 10b maintaining a predetermined gap distance, i.e., a sensor-to-sensor distance D. At this point, each sensor 10a, 10b may be a touchless sensor, e.g., a laser coaxial-displacement sensor, and preferably, may be a confocal sensor using the principle of confocal. Hereinbelow, the disclosure will be described based on the confocal sensor.

The non-contact measuring part is a device measuring surface displacement of the sealing part of the secondary battery, i.e., a measurement target, in the non-contact manner. The pair of the confocal sensors 10a and 10b disposed to face each other with the measurement target located between the sensors irradiates both of upper and lower surfaces of the sealing part with light, and the non-contact measuring part transmits a light receiving signal obtained from the reflected light to the controller.

The controller 20 may calculate a value of the thickness of the sealing part on the basis of data, such as a distance from each sensor to the sealing part, a sensor-to-sensor distance, etc., and based on the calculated value of the thickness of the sealing part, the controller 20 may determine whether or not the sealing part is defective. Of course, the controller 20 may indicate the calculated value of the thickness of the sealing part on a display, and when the value is deviated from a preset thickness range, the controller 20 may output an alarm signal.

As described above, the non-contact measuring part 10 includes the pair of sensors that are disposed to face each other at a preset spacing distance (i.e., sensor-to-sensor distance), and at this point, the sensor-to-sensor distance D is preset to be greater than thickness between the upper surface and the lower surface of the sealing part, more specifically, than the thickness of the secondary battery, thereby allowing the sealing part to easily pass through a gap between the pair of sensors. Accordingly, high-speed measurement is ensured without the need to slow down or stop movement for conventional contact measurement, deformation/damage of the sealing part that is the measurement target due to contact with a probe according to the related art is prevented, and the measurement precision can be ensured.

In addition, the optic axis of a first sensor 10a and the optic axis of a second sensor 10b are aligned coincidentally on the coaxial line. Meanwhile, the optic axis of the first sensor 10a and the optic axis of the second sensor 10b are disposed in a perpendicular direction to a surface of the sealing part of the secondary battery. In other words, the sealing part of the secondary battery may continuously enter in a direction perpendicular to the optic axis of the pair of confocal sensors 10a and 10b so that the degree of measuring the thickness of the measurement target can be increased.

The secondary battery 100 provides a constant width W (referring to FIG. 1) having a range, for example, from 3 mm to 8 mm in the sealing part 111 for ensuring the stability, and the disclosure may measure the thickness of the sealing part while scanning the entirety of the sealing part in a formation direction of the sealing part that passes between the pair of sensors 10a and 10b.

As described above, each sensor 10a, 10b irradiates the upper surface and the lower surface of the sealing part 111 with light by focusing the light in a direction of the optic axis. Of course, each sensor may perform automatic focus adjustment. In order to measure the thickness of the sealing part, the disclosure presets a focus position of each sensor 10a, 10b in the sealing part of the secondary battery, and the focus position of each sensor is positioned at a center portion in the formation direction of the sealing part, and the center portion is a half of the width W of the sealing part.

Then, the disclosure may measure the thickness of the sealing part in the formation direction of the sealing part. Optionally, the disclosure may measure the thickness of the sealing part at various locations thereof in the formation direction thereof. In other words, the disclosure may scan the sealing part 111 along the center portion in the formation direction thereof while maintaining a constant distance between measurement spots of the confocal sensors. A distance of the measurement spots may be less than or equal to for example 1 mm in consideration of measurement speed and measurement accuracy. At this point, thickness measurement precision (resolving power) may be ensured as at least 1 μm or less.

By this configuration, the disclosure measures the thickness of the sealing part in the non-contact manner by means of the confocal sensors, as described above, and may induce precise measurement even under a bent (or folded) deformation state occurring in the sealing part. Moreover, the disclosure may maintain stability and reliability of the secondary battery without deforming the sealing part of the secondary battery due to a press process of supporting or leveling a surface of the measurement target as performed in the related art, as well as excluding inconvenient work such as zero setting of a measurement reference surface.

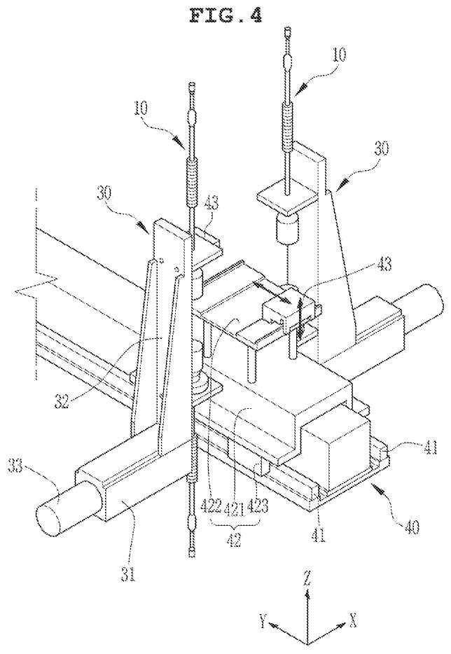

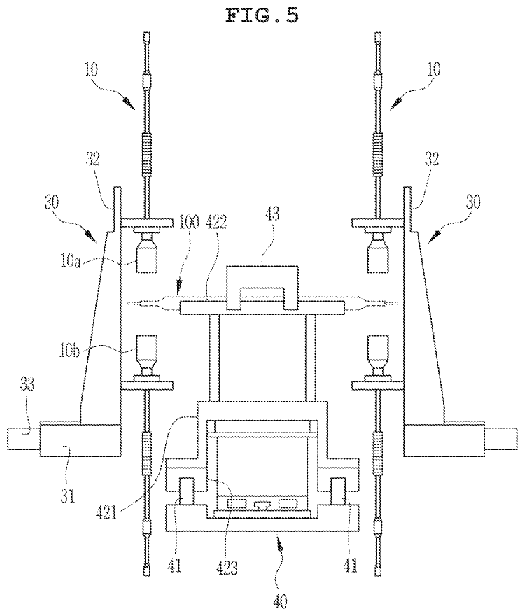

The thickness measurement apparatus according to another embodiment of the disclosure is configure to align the sealing part of the secondary battery within the sensor-to-sensor distance of the non-contact measuring part as shown in FIGS. 4 and 5, and as shown in the drawings, the thickness measurement device is provided to measure the sealing part of the secondary battery in the non-contact manner while moving the measurement target in a direction perpendicular between the pair of sensors vertically disposed to be spaced apart from each other, i.e., in a horizontal direction.

Preferably, the disclosure includes a displacement part 30 that can change a position of the non-contact measuring part 10 with respect to the measurement target. The displacement part 30 may include a sliding guide 31, a slider 32 coupled to the sliding guide 31 to be slidable in a longitudinal direction of the sliding guide 31, and a driving means 33 providing a sliding power to the slider. The slider 32 disposes the non-contact measuring part 10 at a lateral surface facing the measurement target, specifically, the sealing part 111 (referring to FIG. 1) of the secondary battery 100, more specifically, the non-flat side sealing of the sealing part. In addition, the non-contact measuring part 10 may be mounted to the slider 32 so that the pair of sensors 10a and 10b is disposed to vertically face each other and be spaced apart from each other.

The displacement part 30 may move the slider 32 forwards and/or rearwards on the sliding guide 31 by power of the driving means 33 and interpose the sealing part of the secondary battery that is the measurement target between the pair of sensors 10a and 10b. The disclosure provides a characteristic in that it can be applied universally to the secondary battery in various sizes through horizontal displacement adjustment of the non-contact measuring part.

At this point, the sliding guide 31 may extend in an X-axial direction perpendicular to a longitudinal direction of a linear rail 41 to be described below, and the linear rail may mean length extension in a Y-axial direction perpendicular to the X-axial direction. The driving means 33 may be a hydraulic cylinder, a pneumatic cylinder, a driving motor, and is not limited thereto and is fine as the configuration that can move the slider with respect to the sliding guide.

Furthermore, the disclosure may include a linear motion system (LMS) 40 helping the sealing part of the secondary battery to pass through the distance D (referring to FIG. 2) between the sensors that are defined as the first sensor 10a and the second sensor 10b and to be transferred as described above.

The secondary battery 100 is mounted to the linear motion system 40 to measure the sealing part 111 in the non-contact manner while travelling between the pair of sensors 10a and 10b. In other words, the disclosure is provided to allow the sealing part of the secondary battery to continuously enter between the pair of confocal sensors through the linear motion system, and may scan the sealing part in the non-contact manner in a travelling direction of the transfer carrier 42.

At this point, the linear motion system 40 may be a component that moves the measurement target rectilinearly in a horizontal direction, and may include the linear rail 41 extending in a travelling direction of the secondary battery 100, the transfer carrier 42 travelling along with the linear rail 41, and a clamp 43 clamping or unclamping the measurement target on the transfer carrier.

The linear rail 41 may extend horizontally in the travelling direction of the secondary battery so as to induce rectilinear movement of the transfer carrier, and as shown in the drawing, the linear rail 41 may include two rails that are arranged to be in parallel to each other.

The transfer carrier 42 may be moved in an extension direction of the linear rail and simultaneously may mount the measurement target to move the measurement target between the pair of sensors 10a and 10b of the non-contact measuring part 10. The transfer carrier 42 includes a base 421 moved in the extension direction of the linear rail, a seating plate 422 arranged to be spaced apart on the base 421, and a rail groove 423 coupled to the linear rail 41 to be slidingly movable. As is widely known to those skilled in the art, the linear motion system may include the transfer carrier equipped with electromagnet, and a magnet track in which the N and S poles are alternately arranged in a row to generate a magnetic force between the transfer carrier and the same to move the transfer carrier rectilinearly, and the linear motion system may adopt the any configuration that can generate rectilinear movement of the transfer carrier with respect to the linear rail, without being limited thereto. This configuration is the known art, so that a detailed description thereof will be omitted.

The base 421 fixes a location of the seating plate 422 and provides a space that may support and secures the clamp 43. Moreover, the base 421 may include the rail groove 423 corresponding to the linear rail 41 on a lower portion thereof and may be coupled to and arranged to be slidingly movable with respect to the linear rail.

As shown in the drawing, the seating plate 422 has a plate shape on which the secondary battery 100 can be seated. As an upper surface of the seating plate is formed in a shape corresponding to a shape of a lower surface of the secondary battery, insertion and removal of the secondary battery between the pair of sensors may be guided while horizontal alignment of the secondary battery is maintained, as well as the secondary battery may be seated in a regular position with respect to the upper surface of the seating plate.

As described above, the seating plate 422 is arranged to be spaced from above the base 421 at a predetermined interval, and preferably, the seating plate 422 is located higher than the lower second sensor 10b among the pair of the confocal sensors 10a and 10b, and more preferably, the seating plate 422 may be mounted to the base to be adjustable in height so as to be located within the sensor-to-sensor distance between the pair of confocal sensors 10a and 10b. This arrangement allows the linear motion system to move the sealing part of the secondary battery between the pair of confocal sensors.

As shown in the disclosure, in the linear motion system, the clamp 43 ensures the mounting stability as well as the horizontality of the secondary battery by clamping the secondary battery 100 seated on the seating plate 422, thereby preventing accidents such as deviation of the secondary battery and precisely measuring the thickness of the sealing part that is a measurement portion.

As shown in the drawing, the disclosure is provided to clamp the opposite side portions in the travelling direction of the secondary battery while arranging clamps 43 to be spaced apart from each other at an interval, at the opposite side portions of the seating plate 422 of the transfer carrier. The pair of clamps 43 is arranged to be spaced apart from each other to be mirror-symmetric based on the seating plate in the extension direction of the linear rail or the travelling direction of the secondary battery, and clamps a portion inside each of opposite ends of the secondary battery close to the flat-side sealing 111b (referring to FIG. 1) without the electrode lead. Even when the secondary battery is mounted to the transfer carrier 42, the non-flat side sealing portion 111a where the electrode lead is drawn may be disposed to protrude outwards, so that the thickness of the sealing part can be measured only by the process in which the secondary battery travels between the pair of sensors.

Each of the clamps 43 has a jig structure that vertically moves in a Z-axial direction above the seating plate 422, and may be provided to clamp and unclamp the secondary battery held on the seating plate. Moreover, in order to grip the secondary battery having various sizes located on the seating plate 422 of the transfer carrier, the disclosure may be designed to move each clamp horizontally in the Y-axial direction (travelling direction of the secondary battery or extension direction of linear rail) and/or vertically in the Z-axial direction. In the embodiment of the disclosure, the transfer carrier is illustrated without detailed description and drawings of a transfer member that moves each clamp in the Y-axial direction and the Z-axial direction on an upper surface of the seating plate.

Optionally, the disclosure may be provided such that the displacement part 30 is arranged to be mirror symmetric with the linear motion system 40 as the center. This arrangement may allow simultaneously measurements with respect to sealing parts on the opposite ends of the secondary battery where the electrode leads 120 extend in opposite directions on the opposite ends of the electrode assembly, i.e., extend bi-directionally (two ways) to face each other.

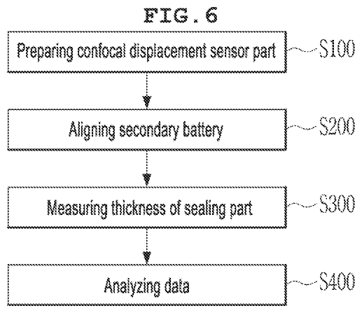

Hereinbelow, a method for measuring the thickness of the sealing part of the pouch-type secondary battery by using the non-contact measuring part will be described with reference to FIG. 6.

For reference, FIG. 6 is described as a series of steps, but the order of these steps may be changed in another embodiment, and some steps that are shown and/or described may be entirely or partially omitted. Of course, it should be noted in advance that the disclosed method is also applicable to thickness measurement apparatus having other structures.

Preferentially, the disclosure may include preparing the non-contact measuring part 10 having the pair of sensors 10a and 10b spaced apart from each other while facing each other and arranged coaxially, preferably, the pair of confocal sensors, at S100 (referring to FIG. 2). At this point, each sensor 10a, 10b may be a touchless sensor, e.g., a laser coaxial-displacement sensor, and preferably, may be a confocal sensor.

The non-contact measuring part 10 maintains the sensor-to-sensor distance between the pair of sensors 10a and 10b constant. Accordingly, the disclosure may calculate the thickness of the sealing part on the basis of the distance between the upper surface and the lower surface of the sealing part of the secondary battery, the distance being detected by the pair of sensors 10a and 10b and the preset sensor-to-sensor distance D.

Furthermore, the non-contact measuring part prevents contact between the first sensor 10a at the upper side among the pair of sensors and the upper surface of the sealing part of the secondary battery and prevents contact between the second sensor 10b at the lower side and the lower surface of the sealing part of the secondary battery, in advance, thereby allowing continuous movement the sealing part of the secondary battery, i.e., the measurement target, in the travelling direction between the pair of sensors in the non-contact state.

Furthermore, the disclosure includes aligning the secondary battery to guide the sealing part 111 of the secondary battery 100 to be located between the pair of sensors, at S200.

In the aligning of the secondary battery at S200, the disclosure may include presetting the height of the measurement target to correspond to the sensor-to-sensor distance D of the non-contact measuring part 10, and presetting orienting so as for a measurement portion of the measurement target to be located between the pair of sensors.

At this point, the presetting of the height of the measurement target is performed by arranging the height position of the secondary battery between the pair of sensors 10a and 10b constituting the non-contact measuring part 10, and preferably, by adjusting the height of the secondary battery so that the sealing part 111 of the secondary battery is located at a center position between the pair of sensors 10a and 10b. In other words, in the presetting of the height of the measurement target, the sealing part of the secondary battery is located at a ½ spot of the sensor-to-sensor distance.

Furthermore, in the presetting of the height of the measurement target, the disclosure may include aligning the sealing part of the secondary battery 100 positionally fixed on the seating plate 422 of the linear motion system 40 within the sensor-to-sensor distance defined by the pair of sensors coaxially arranged (referring to FIGS. 4 and 5). Therefore, the above-described configuration moves the displacement part equipped with the pair of sensors slidingly in the X-axial direction at each side surface of the linear motion system to reliability align the sealing part between the pair of sensors.

The presetting of direction of the measurement target is performed by arranging the measurement portions of the measurement target in a direction perpendicular to the installation direction of the pair of sensors 10a and 10b coaxially arranged, and simultaneously, by interposing the measurement portions of the measurement target between the pair of sensors 10a and 10b. Selectively, the measurement portions of the measurement target are arranged in parallel to the travelling direction of the secondary battery.

Therefore, the above-described linear motion system may ensure the secondary battery to be continuously moved in a direction perpendicular to the installation direction of the pair of sensors and scanning with respect to the entirety of the section of the sealing part. At this point, each measurement portion may be the sealing part of the secondary battery, e.g., the non-flat side sealing portion 111a, and when the need should arise, may be the flat side sealing portion 111b (as shown in FIG. 1).

Then, the disclosure may include measuring, at S300, the thickness of the sealing part while the sealing part of the secondary battery is continuously moved between the pair of sensors 10a and 10b constituting the non-contact measuring part 10.

The disclosure may maintain the constant horizontality of the secondary battery that is continuously moved within the sensor-to-sensor distance D defined by the pair of sensors 10a and 10b to ensure the excellent performance of measurement and as a result to obtain accurate and precise measured results with respect to the thickness of the sealing part.

Selectively, the secondary battery 100 may be mounted for example to the linear motion system to travel across between the pair of sensors. In other words, the disclosure is configured to irradiate the upper and lower surfaces of the sealing part that is moved across between the sensor-to-sensor distance of the non-contact measuring part with light, and through the data such as a distance from each sensor to a facing surface of the sealing part and the preset sensor-to-sensor distance, which is obtained through the light receiving signal obtained from the reflected light, by the controller 20, the disclosure can calculate the thicknesses at various spots in the formation direction of the sealing part.

Each sensor 10a, 10b irradiates the upper surface and the lower surface of the sealing part 111 with light by focusing the light in a direction of the optic axis. Of course, each sensor may perform automatic focus adjustment. In order to measure the thickness of the sealing part, the disclosure presets a focus position of each sensor 10a, 10b in the sealing part of the secondary battery, and the focus position of each sensor is positioned at a center portion in the formation direction of the sealing part, and the center portion is a ½ spot of the width W of the sealing part.

The disclosure provides the characteristic in that it can continuously measure the thickness along the sealing part of the secondary battery. For example, the transfer carrier travels at constant speed for example at moving speed of 200 mm/sec to guide thickness measurement to be performed in various spots in the formation direction of the sealing part. In addition, the disclosure may scan the sealing part along the center portion in the formation direction thereof while maintaining a distance between measurement spots of the confocal sensors. A distance of the measurement spots may be less than or equal to for example 1 mm in consideration of measurement speed and measurement accuracy.

The transfer carrier 42 is provided to be travelable along the linear rail 41, and may support the secondary battery by clapping the pouch body of the secondary battery. Selectively, in the disclosure, it is fine to adopt any clamp that can clamp the secondary battery while the measurement portion, i.e., the sealing part is exposed on the seating plate.

Finally, the disclosure includes calculates the thickness of the sealing part measured by the non-contact measuring part 10 to the controller 20 and analyzing data whether or not the sealing part is defective, at S400.

In the embodiment of the disclosure, the analyzing of the data at S400 may determine whether or not the sealing part is defective, through the measured thickness of the sealing part. The disclosure has the characteristic in that thickness measurement is performed at the same time with moving the secondary battery.

The controller 20 analyzes the received data on the basis of the thickness information of the sealing part measured by the non-contact measuring part, and when a value is within a permissible (error) range, the controller 20 determines that the secondary battery is a perfect product, and when a value is outside the permissible (error) range, the controller 20 determines that the secondary battery is a defective product.

The analyzing of the data at S400 is performed by calculate deviation by comparing a measured thickness of the sealing part on the basis of a preset thickness target value of the sealing part by the controller, and by outputting an alarm signal when the calculated deviation is close to or outside the certain permissible range.

Hereinabove, the disclosure has been described in detail with the embodiment. The embodiments are for specifically describing the disclosure, and the disclosure is not limited thereto. It will be clear that variations or improvements are possible by those skilled in the art within the technical idea of the disclosure.

All simple variations or modifications of the disclosure belongs within the scope of the disclosure, and the protection scope of the disclosure will be clarified by the appended claims.

1. Apparatus for measuring thickness of a sealing portion of a secondary battery, the apparatus comprising:
a non-contact measuring part comprising a pair of sensors disposed to face each other; and
a controller detecting thickness information of the sealing part of the secondary battery, the information being collected by the non-contact measuring part,
wherein the non-contact measuring part is able to measure the thickness in a non-contact manner while interposing the sealing part of the secondary battery between the pair of sensors.

2. The apparatus of claim 1, wherein the non-contact measuring part is disposed to space the pair of sensors from each other at a sensor-to-sensor distance.

3. The apparatus of claim 1, wherein a sensor-to-sensor distance is preset larger than the thickness between an upper surface and a lower surface of the sealing part.

4. The apparatus of claim 1, wherein the sensors include confocal sensors.

5. The apparatus of claim 1, further comprising:
a displacement part displacing a location of the non-contact measuring part with respect to the sealing part of the secondary battery.

6. The apparatus of claim 1, wherein the secondary battery is mounted to a linear motion system to be continuously moved in a direction perpendicular to an optic axis of the pair of sensors.

7. A method for measuring thickness of a sealing portion of a secondary battery, the method comprising:
preparing a non-contact measuring part comprising a pair of sensors disposed to face each other;
aligning the secondary battery in order to interpose the sealing part of the secondary battery between the pair of sensors;
measuring the thickness of the sealing part in a formation direction of the sealing part by the non-contact measuring part; and
analyzing data to determine thickness information collected by the non-contact measuring part,
wherein the non-contact measuring part measures the thickness of the sealing part of the secondary battery in the non-contact manner.

8. The method of claim 7, wherein the aligning of the secondary battery comprising:
presetting height of the secondary battery to correspond to a sensor-to-sensor distance; and
presetting orienting so as for the sealing part of the secondary battery that is a measurement portion, to be located between the pair of sensors.

9. The method of claim 7, wherein the sealing part where an electrode lead is drawn outwards is disposed between the pair of sensors.

10. The method of claim 7, wherein in the measuring of the thickness of the sealing part, the sealing part of the secondary battery is continuously moved in a direction perpendicular to an optic axis of the pair of sensors.

11. The method of claim 7, wherein in the measuring of the thickness of the sealing part, the secondary battery is mounted to a linear motion system to travel at a constant speed.

12. The method of claim 7, wherein the pair of sensors is disposed to be spaced from each other at a sensor-to-sensor distance that is larger than the thickness between an upper surface and a lower surface of the sealing part.
